(19) United States
(12) Patent Application Publication
(10) Pub. No.: US 2022/0012737 A1
(43) Pub. Date: Jan. 13, 2022

(54) POST-TRANSACTION TIPPING WITH MODIFIED TRANSACTION MESSAGE FIELDS

(71) Applicant: VISA INTERNATIONAL SERVICE ASSOCIATION, San Francisco, CA (US)

(72) Inventors: Navendu MISRA, Austin, TX (US); Srijith KARIPPURE, Austin, TX (US); Isha GADEKAR, Austin, TX (US); Roshni Ann SAMUEL, Austin, TX (US); Manipal BHOOMPALLY, Austin, TX (US)

(21) Appl. No.: 17/294,053

(22) PCT Filed: Nov. 27, 2018
(86) PCT No.: PCT/US18/62672

§ 371 Date: May 14, 2021

(51) Int. Cl. G06Q 20/40; G06Q 20/38; G06Q 20/20; G06Q 20/10

(52) U.S. Cl. CPC G06Q 20/405; G06Q 20/401; G06Q 20/102; G06Q 20/20; G06Q 20/38215

(57) ABSTRACT

A transaction server receives a request from a POS device of a merchant. The server determines whether a merchant ID in the request matches with one stored in a database. If yes, the server automatically amends a first field with a predetermined secondary value associated with the merchant ID and updating a total in a second field as a sum of the value of the transaction and the predetermined secondary value. The server processes the request as a single request with the total in the second field. In one embodiment, if no, the server monitors subsequent streams of requests having the encrypted account and the merchant ID. Once identified, the server amends the first field with the subsequent value and updating the total in the message field as a sum of the value of the transaction and the subsequent value and processes the electronic transaction request as the single request.

### TECHNICAL FIELD

Embodiments of the invention generally relate to post-transaction modification of electronic transactions.

### BACKGROUND

Non-cash payment means, such as credit cards, debit cards, mobile payments, contactless payments, etc., have drastically change spending habits for consumers. These payment mechanisms have evolved overtime; from a plastic card with magnetic stripes to cards with advanced security technology such as (EMV) cards. Other functionalities have also added such as contactless devices or transponders have embedded into the cards themselves.

Moreover, with the versatility of mobile devices and the software installed thereon (e.g., apps), convenience of making payments has further increased when payment mechanisms have transformed to the software installed on the mobile devices. Contactless hardware chips are now commonplace in mobile devices (e.g., mobile phones and smartwatches) to enable consumers to link the mobile devices to accounts associated with their cards for payments. With the stronger security mechanisms available on the mobile devices, it is even more reliable than the physical card itself.

However, as consumers conduct more transactions via these non-cash payment mechanisms, consumers are missing out the contributions to the traditional “tip jar” at quick service restaurants or establishments. This kind of contributions occur after a transaction has completed and differs significantly from the existing exemplary practice, which typically includes the following steps when a consumer dines at a restaurant and present a non-cash payment mechanism for payment:
Waiter drops off bill
Customer puts credit card into portfolio
Waiter takes card back to wait-station and processes the card at a point-of-sale (POS) station
The POS station sends a transaction authorization to be processed
At the POS station, the Waiter would not “close check” after processing the card (instead, the process is “open” or “pending”
Waiter returns with receipt for customer tip and Signature
Customer adds tip and signs receipt
Waiter picks up receipt and enters a new total, with tip, to the “open” or “pending” check at the POS station and
Waiter finally closes the check and the POS station sends a transaction adjustment with tips to replace the transaction authorization.

In other words, the technical problem with the “tip jar” scenario is that, unlike the restaurant-tipping example above, the transaction before tipping has completed. It was not an authorization and there was no “open” or “pending” status for the POS station to “close” after entering a new amount. The POS station has transmitted a completed transaction data packet to the payment processor for verification and the eventual payment from an issuer to the merchant. Second, the post-transaction tipping may be treated as a second transaction and, since they are tips, the amounts are typically small and may sometimes flagged by issuing banks as potential fraudulent transaction. If the consumer fails to follow-up with the issuer to confirm that the amounts were not fraudulent, the issuing banks will cancel the transaction—thus defeating the purpose of tipping—which may aim to help supplement minimum wage earning waiter or waitress.

Embodiments of the invention attempt to solve or address one or more of the technical problems identified.

### SUMMARY

Embodiments of the invention may provide a new technical solution by creating a header or a similar data field in a transaction header enabling the transaction processor to modify or amend the header field to reflect a post-transaction tip such that the post-transaction tip is not treated as a separate and discrete transaction. Aspects of the invention further provide a user interface enabling a user to set a predetermined amount of tip at quick service establishments.

### BRIEF DESCRIPTION OF THE DRAWINGS

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a diagram illustrating a data packet structure according to one embodiment of the invention.

FIG. 2 is a system diagram according to another embodiment of the invention.

FIG. 3 is a flowchart illustrating a computerized method according to one embodiment of the invention.

FIGS. 4A to 4B are diagrams illustrating graphical user interface (GUI) on a configuration portal according to one embodiment of the invention.

FIG. 5 is a diagram illustrating graphical user interface (GUI) on a mobile device according to one embodiment of the invention.

FIG. 6 is a diagram illustrating a portable computing device according to one embodiment of the invention.

FIG. 7 is a diagram illustrating a remote computing device according to one embodiment of the invention.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

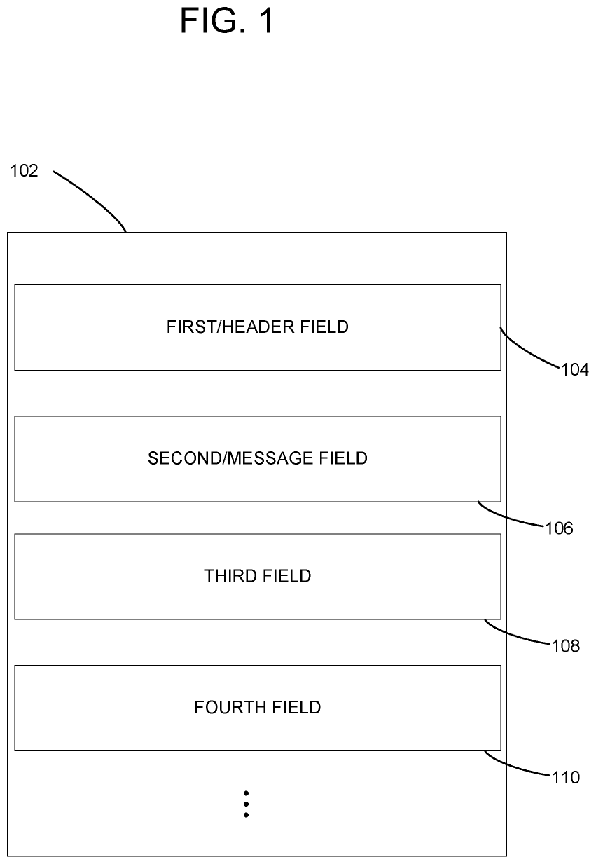

Referring now to FIG. 1, a diagram illustrates a data structure 102 of a data packet of an electronic transaction request. In one example, the data structure 102 defines an exemplary data packet format with value definitions or a schema for a given electronic transaction request to be processed by a transaction processing server. The data structure 102 may include a first or header field 104. In one example, the first field 104 may include a declaration of the format or schema, a version of the format or the schema, or other information. In one embodiment, the first field 104 may include information or data related to a post-transaction tip or gratuity value or amount that a user may wish to add after an electronic transaction has completed.

In one embodiment, a user may visit a quick service merchant (hereinafter “merchant”) which may be a small business establishment, such as a local coffee shop. After placing the order at the merchant, the user has completed her transaction. However, before departing the merchant, the user may wish to add a tip to assist the waiter, waitress, or a staff who may be earning a minimum wage. Instead of the conventional “tip jar” using cash, the user may not have cash in hand and it may not be prudent to ask for the waiter, waitress, or staff's phone number to perform a quick “cash” transfer over a mobile device of the user. As such, the user would like to give the tip or gratuity to the abovementioned individual.

Embodiments of the invention enable such capabilities by providing a technical solution starting from the data structure 102 with the first field 104. The first field 104 may reserve a data storage space for storing such information when an amount of the tip or gratuity may be amended or inserted after the transaction by the user at the merchant has completed.

Still referring to FIG. 1, the data structure 102 further may include a second or message field 106 for storing information or data such as amount of the transaction. In one example, the second field 106 may include a currency designation (e.g., USD, EU, etc.), and a numerical value for the transaction. In another embodiment, the second field 106 may further include a total of the transaction. The data structure 102 further includes a third field 108 which may store information or data such as a name of the merchant, an address of the merchant, a merchant identifier (ID). The data structure 102 may include a fourth field 110 which may store information or data such as an encrypted account number of the payment device that the user uses to pay for the transaction, an account identifier (ID) associated with the user, or other information.

In one embodiment, the data structure 102 may include other data fields needed for processing the transaction by the transaction processing server. In another embodiment, the data structure 102 may be tokenized or encrypted to protect the sensitivity of the data.

Unlike previous approaches relating to providing a tip or gratuity at a restaurant after a consumer has finished the meal, the practice in such approach fails to close or “complete” the transaction. Instead, it was left in an open or pending status such that the restaurant staff may return to the transaction to close it with the tip or gratuity amount.

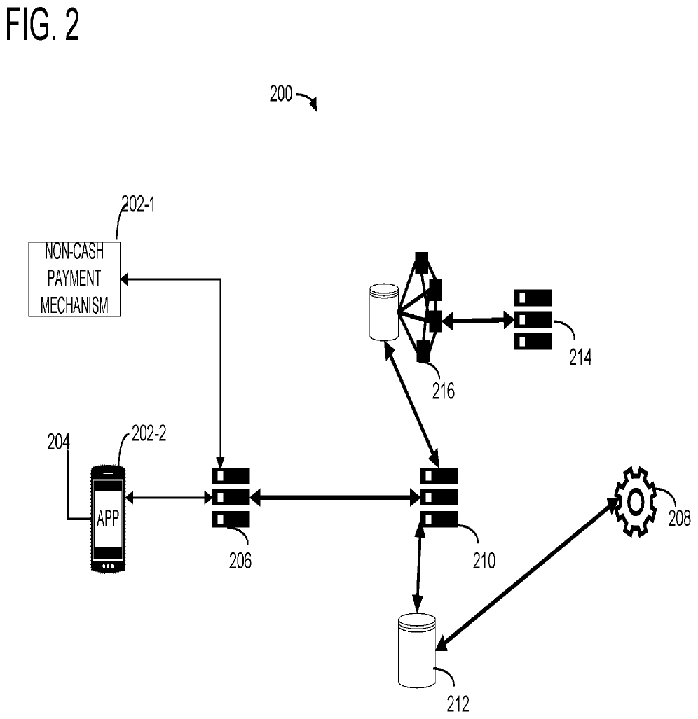

FIG. 2 is a system diagram illustrating one embodiment of the invention. For example, a system 200 may include a server 210 that may exchange and process data packets between a frontend server (not shown), a database server/database 212, and/or a server for an issuer 216. In one embodiment, the server 210 may further exchange and process data packets from an application (hereinafter “app”) 204 installed on a mobile device 202-2.

In one embodiment, the server 210 may process electronic transaction requests received at a merchant 206, having a merchant ID associated therewith. For example, a user may present a non-cash payment mechanism 202-1 or the mobile device 202-2 (where the non-cash payment mechanism 202-1 may have already be linked or registered with the mobile device 202-2 such that the user may not need to provide a physical mechanism) at a point-of-sale (POS) device connected to the merchant 206. The POST device of the merchant 206 receives the information from the mechanism 202-1 or the mobile device 202-2 and combines with the transaction in question before sending them to the server 210 in a format or schema defined by the server 210, such as the data structure 102. The server 210 may examine the data content of the data structure 102 to ensure the data content was authenticated before forwarding it to the issuer 216, which may perform further verification or authentication with its servers 214. Once authenticated, the merchant 206 may be paid and the account associated with the non-cash payment mechanism 202-1 or the mobile device 202-2 may be deducted for the amount of the transaction.

Aspects of the invention provide the database server or database 212 accessible by the server 210 for providing an automatic tip or gratuity added to the transaction request in the above example. In other words, instead of creating a second and separate transaction to be processed, the server 210 intelligently recognizes a subsequent transaction as a tip or gratuity transaction.

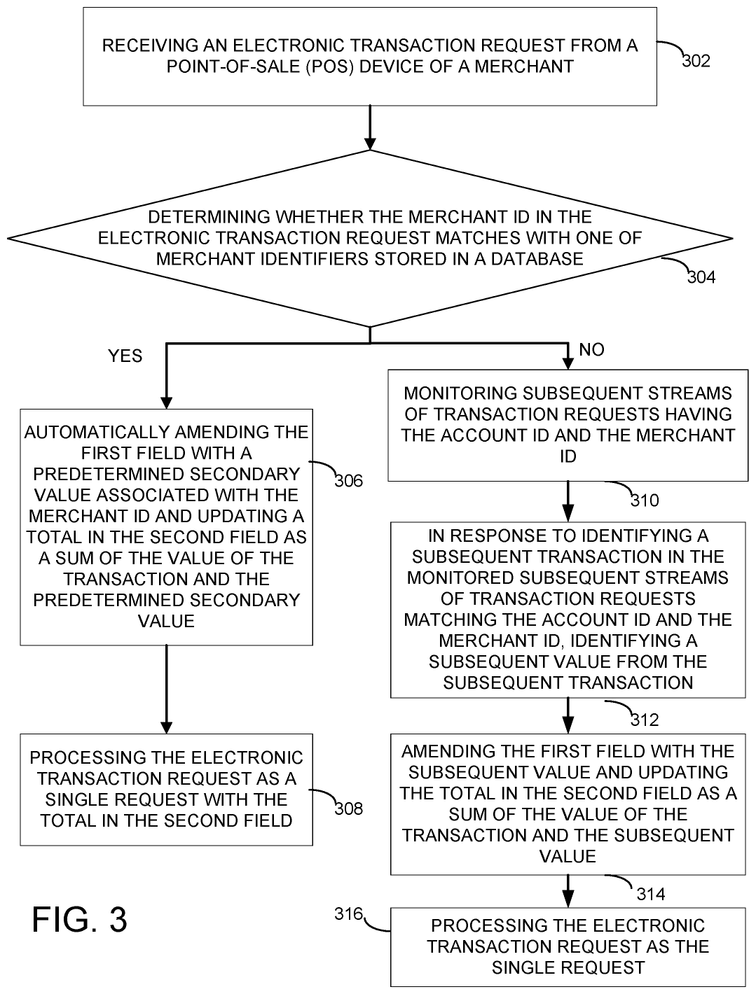

To further illustrate these embodiments, FIG. 3 is a flowchart diagram describing one exemplary operation of one embodiment of the invention. In one example, the server 210 may receive an electronic transaction request from the POS at the merchant 206 for processing at 302. Upon receiving such request, at 304, the server 210 may determine whether the merchant 206 whose merchant ID may be in the database 212 already. In one embodiment, the database 212 may store a collection of merchant IDs that users may identified as merchants that users wish to provide tips or gratuities. In one embodiment, the system 200 may further include a configuration portal 208 which enable the user under his or her account ID to configure preferences about tips or gratuities for merchants. In another embodiment, the system 200 may provide the configuration portal 208 to administrators of the server 210 to provide further administration tasks or controls.

If the determination is positive, the server 210 automatically may amend the first field (e.g., first field 104) with a predetermined secondary value (e.g., tip or gratuity) associated with the merchant ID and may update a total in the second field (e.g., second field 106) as a sum of the value of the transaction and the predetermined secondary value at 306. In this example, once the server 210 recognizes that the user has, through the configuration portal 208, predefined a tip or gratuity amount for the merchant 206, the server 210 may retrieve such tip/gratuity amount and applies it to the total of the transaction. In this instance, the user may not need to perform an overt act of providing the tip/gratuity at the merchant 206. In a further embodiment, the server 210 may also waive any merchant transaction fee for the tip/gratuity.

At 308, the server 210 processes the request as a single request with the total amount in the second field.

If the determination is negative, the server 210, at 310, may monitor subsequent streams of requests having the account ID and the merchant ID in the requests. At 312, in response to identifying a match in the subsequent streams of requests, the server 210 may identify a subsequent value from the matched subsequent transaction. In one example, the subsequent value may be the tip/gratuity that the user may wish to provide after the transaction at the merchant 206 has completed.

The server 210 may amend the first field of the original transaction with the subsequent value (e.g., tip/gratuity) and may update the total to be a sum of the value of the transaction and the subsequent value at 314. At 316, the server 210 may process the request as the single request.

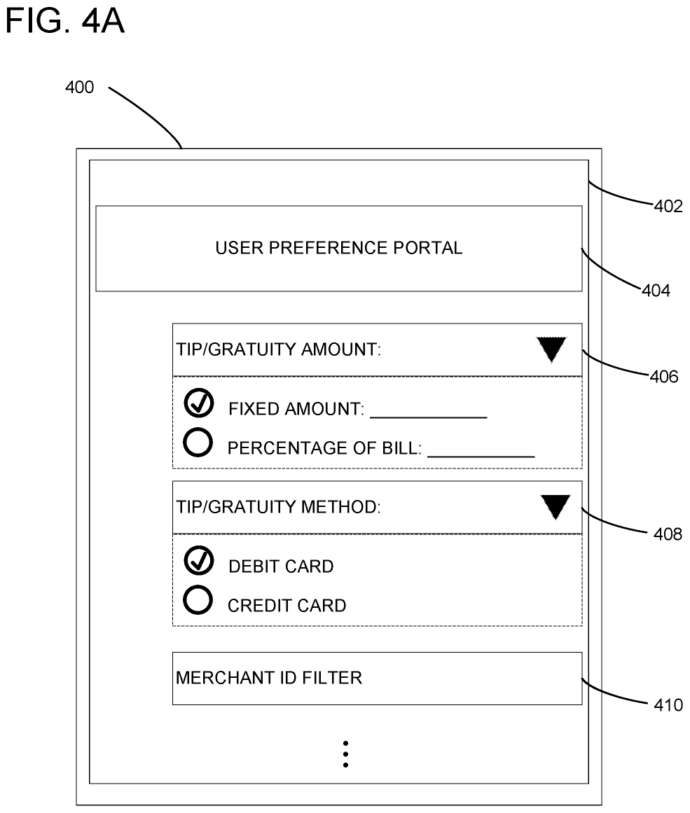

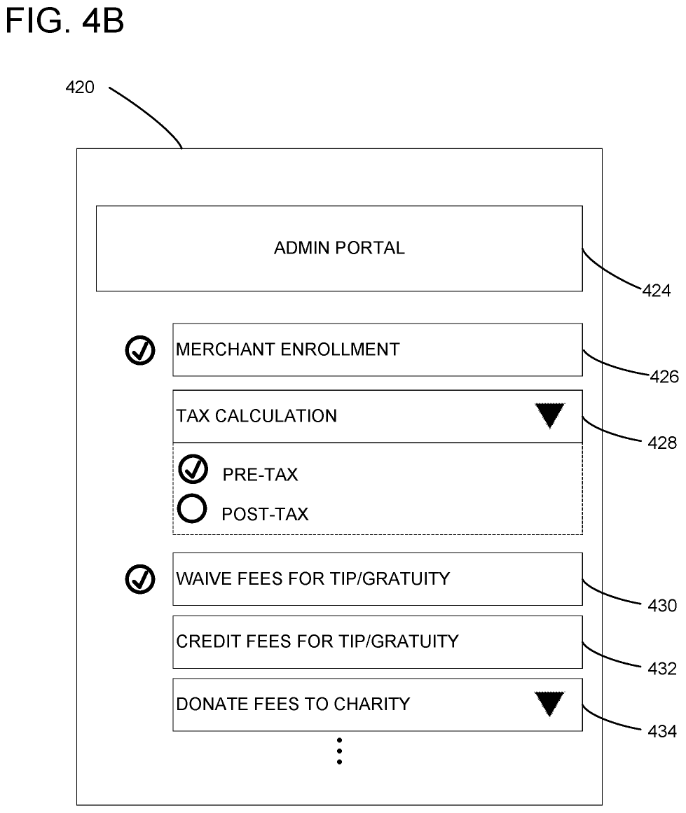

Referring now to FIG. 4A, a graphical user interface (GUI) 400 on a configuration portal (e.g., configuration portal 208) is illustrated according to one embodiment of the invention. In one embodiment, the GUI 400 provides a view 402 showing a header 404 to inform the user that this is a portal for the user to set his or her preferences. In one example, the view 402 may be presented via a web site such that the user may view it across various devices. In another example, the view 402 may be presented via the app 204 on the mobile device 202-2.

In one embodiment, the view 402 may include a first preference setting 406 for configuring an amount of the tip/gratuity. For example, the first preference setting 406 may provide further choices of a fixed amount or as a percentage of the bill or transaction that has completed earlier.

The view 402 may further include a method of the tip/gratuity in a second preference 408. For example, the second preference setting 408 may include a choice of a debit card, a credit card, or other funding sources. In another example, the view 402 may further include a third preference setting 410 to enable the user to filter merchants. In one example, the user may filter the merchants by merchant ID. In another example, the user may filter the merchants by region or geographical locations. In a further example, the user may filter the merchants based on types of establishments or whether the merchant is a small business, etc.

It is to be understood that other preference settings may be added without departing from the scope or spirit of embodiments of the invention.

Referring now to FIG. 4B, a GUI 420 may be presented to an administrator of the server 210 or an administrator of the issuer 216. In one example, the GUI 420 may be incorporated into an existing configuration portal for the administrator of the server 210 or the issuer 216. In another example, the GUI 420 may include a header 424 indicating to the administrative user or a user with administrative rights. The GUI 420 may further include a first setting 426 indicating a status of an enrollment by the merchant to the tip/gratuity processing scheme. In another embodiment, the GUI 420 may include a second setting 428 for indicating whether a setting of calculating taxes of the transaction; whether it's pre-tax or post-tax. The GUI 420 may further include a third setting 430 for indicating whether the server 210 may waive merchant transaction fees for the tip/gratuity that may be added to a transaction. In another embodiment, the GUI 420 may further include a fourth setting 432 for crediting merchant for fees from tip/gratuity such that the credits may be used for future charges. In another embodiment, the GUI 420 may include a fifth setting 434 if the merchant may request the waived fees to be donated to a charity of choice of the merchant. As such, the GUI 420 of the configuration portal may provide settings for the administrator of the server 210 or issuer 216 a variety of settings for managing merchants who may wish to be part of this post-transaction adjustment scheme as described.

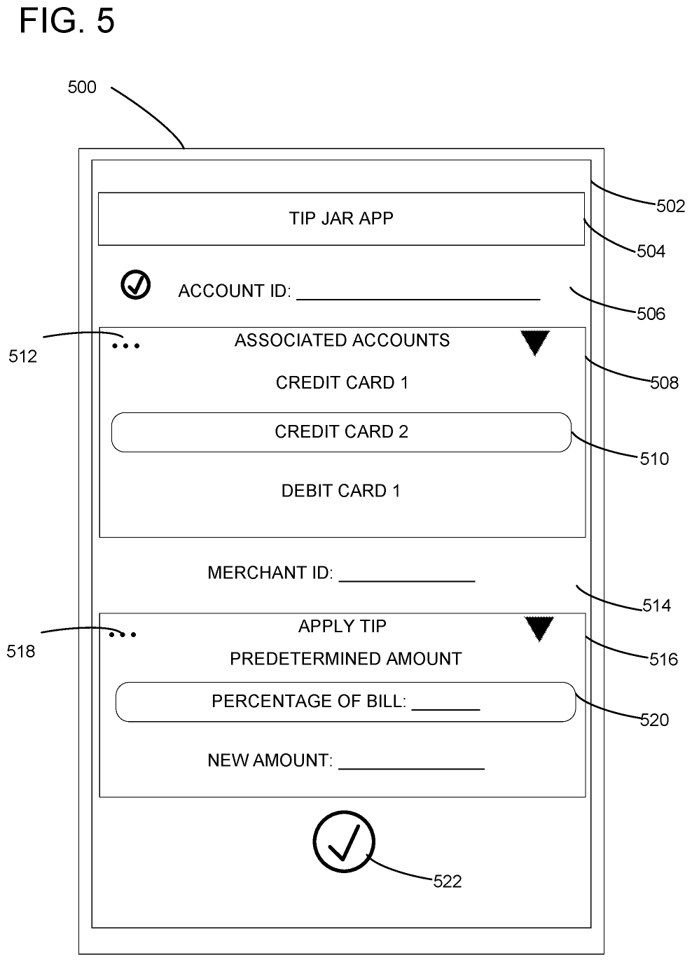

In another embodiment, FIG. 5 may be another GUI 500 to be presented on the app 204 such that the user may quickly give tip/gratuity to the merchant 206 or a merchant identified in a field 514. In one embodiment, the GUI 500 may provide a view 502 with a header 504 to identify the view. The view 502 may further identify a user 506 by displaying the account ID of the user. The view 502 may further include a pane 508 showing one or more associated accounts. In one example, the user may have a credit card 1, a credit card 2, and a debit card 1 as associated accounts. In one example, the pane 508 illustrates a selection 510 showing that the user either has selected “credit card 2” as the card to be used for tip/gratuity or that the “credit card 2” has been preselected. The user may modify the selection by selecting (e.g., double tapping, pressing for a few seconds, a single tap, or other gestures) a menu 512. In another embodiment, the view 502 may further identify in a field 514 showing a merchant ID of the merchant that will receive the tip/gratuity. The view 502 may further include a pane 516 for displaying an amount of tip/gratuity. For example, the pane 516 may include options such as a predetermined amount, a percentage of a bill, or a new amount to be entered by the user. In this example, a selection 520 may indicate that the user may have preselected that option or has now selected that option. The view 502 may provide an indicator 522 in the form of a checkmark to confirm the payment of the tip/gratuity.

It is to be understood that other options that are in line with the ones shown in the view 502 may be presented without departing from the scope or spirit of embodiments of the invention.

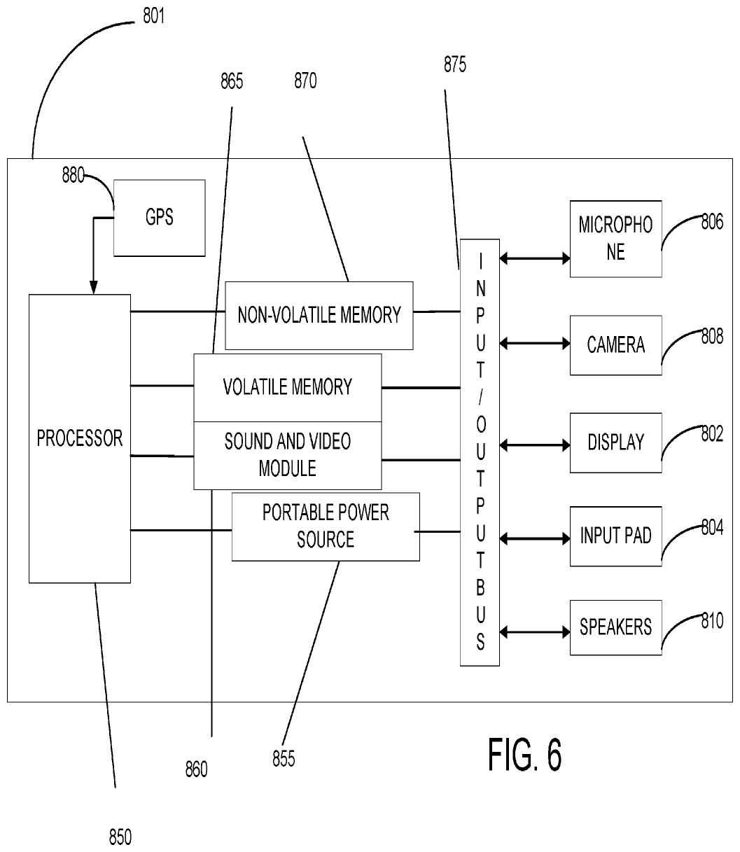

FIG. 6 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages, and different API platforms.

In one embodiment, a portable computing device 801 may be a mobile device 112 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

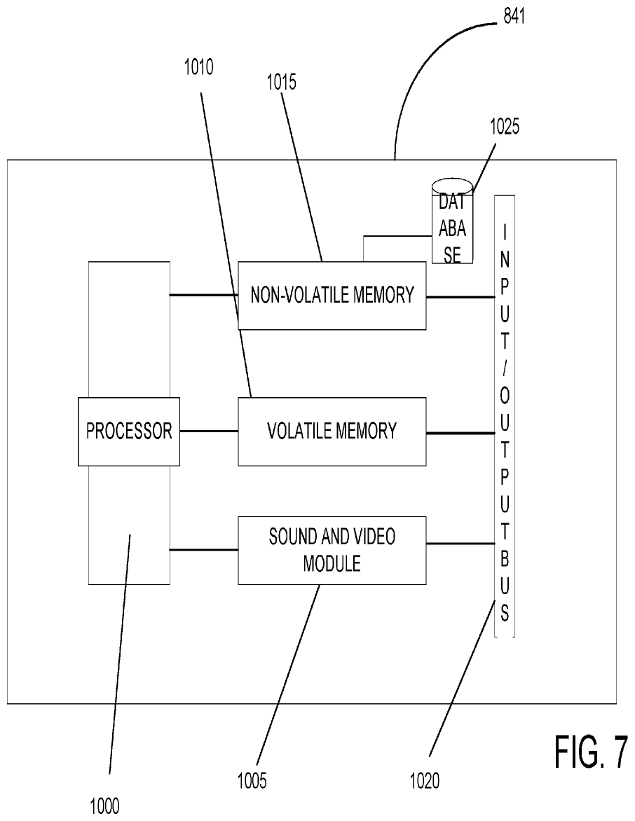

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be general purpose computers that may have, among other elements, a microprocessor (such as from the Intel Corporation, AMD, ARM, Qualcomm, or MediaTek); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, iOS, Android, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving transaction data message processing by enabling modification of the data message fields after the transaction has completed. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computerized method executable on a transaction server comprising:
receiving an electronic transaction request from a point-of-sale (POS) device of a merchant, said electronic transaction request comprising a request data packet with at least a header field and a message field, said message field including a value of a transaction and an encrypted account of a user, said merchant having a merchant identifier (ID) associated therewith;
determining whether the merchant ID in the electronic transaction request matches with one of merchant identifiers stored in a database, said database being connected to the transaction server;
in response to the determining being positive, automatically amending the header field with a predetermined secondary value associated with the merchant ID retrieved from the database and updating a total in the message field as a sum of the value of the transaction and the predetermined secondary value;
processing the electronic transaction request as a single request with the total in the message field; or
in response to the determining being negative, monitoring subsequent streams of transaction requests having the encrypted account and the merchant ID;
in response to identifying a subsequent transaction in the monitored subsequent streams of transaction requests matching the encrypted account and the merchant ID, identifying a subsequent value from the subsequent transaction;
amending the header field with the subsequent value and updating the total in the message field as a sum of the value of the transaction and the subsequent value; and
processing the electronic transaction request as the single request.

2. The computerized method of claim 1, further comprising providing a graphical user interface (GUI) to the user to configure conditions for the predetermined secondary value.

3. The computerized method of claim 2, wherein the conditions comprise at least one of the following: a fixed value of the predetermined secondary value; a region where a merchant is located, a type of the merchant, and whether a review of the merchant has received.

4. The computerized method of claim 1, wherein the encrypted account of the user comprises a user identifier.

5. The computerized method of claim 1, further comprising determining a pre-tax amount before the predetermined secondary value or the subsequent value is added to the total.

6. The computerized method of claim 1, further comprising determining a post-tax amount of the total.

7. A computerized method executable on a transaction server comprising:
receiving an electronic transaction request from a point-of-sale (POS) device of a merchant, said electronic transaction request comprising a request data packet with at least a first field and a second field, said message field including a value of a transaction and an account identifier (ID) of a user, said merchant having a merchant identifier (ID) associated therewith;
determining whether the merchant ID in the electronic transaction request matches with one of merchant identifiers stored in a database, said database being connected to the transaction server;
in response to the determining being positive, automatically amending the first field with a predetermined secondary value associated with the merchant ID retrieved from the database and updating a total in the second field as a sum of the value of the transaction and the predetermined secondary value;
processing the electronic transaction request as a single request with the total in the second field; or
in response to the determining being negative, monitoring subsequent streams of transaction requests having the account ID and the merchant ID;
in response to identifying a subsequent transaction in the monitored subsequent streams of transaction requests matching the account ID and the merchant ID, identifying a subsequent value from the subsequent transaction;
amending the first field with the subsequent value and updating the total in the second field as a sum of the value of the transaction and the subsequent value; and
processing the electronic transaction request as the single request.

8. The computerized method of claim 7, further comprising providing a graphical user interface (GUI) on a user device of the user for configuring preferences for the predetermined secondary value.

9. The computerized method of claim 8, wherein the preferences comprise at least one or more of the following: a fixed value of the predetermined secondary value; a region where a merchant is located, a type of the merchant, and whether a review of the merchant has received.

10. The computerized method of claim 7, wherein the account ID of the user identifies a first payment account used in the electronic transaction request.

11. The computerized method of claim 7 wherein the account ID of the user identifies a second payment account used in the subsequent transaction.

12. The computerized method of claim 7, further comprising determining a pre-tax amount before the predetermined secondary value or the subsequent value is added to the total.

13. The computerized method of claim 7, further comprising determining a post-tax amount of the total.

14. A non-transitory computer readable medium storing computer-executable instructions embodied in a software product to be installed on a mobile device, said computer-executable instructions executable by a transaction server comprising:
receiving an electronic transaction request from a point-of-sale (POS) device of a merchant, said electronic transaction request comprising a request data packet with at least a first field and a second field, said message field including a value of a transaction and an account identifier (ID) of a user, said merchant having a merchant identifier (ID) associated therewith;
determining whether the merchant ID in the electronic transaction request matches with one of merchant identifiers stored in a database, said database being connected to the transaction server;
in response to the determining being positive, automatically amending the first field with a predetermined secondary value associated with the merchant ID retrieved from the database and updating a total in the second field as a sum of the value of the transaction and the predetermined secondary value;
processing the electronic transaction request as a single request with the total in the second field; or
in response to the determining being negative, monitoring subsequent streams of transaction requests having the account ID and the merchant ID;
in response to identifying a subsequent transaction in the monitored subsequent streams of transaction requests matching the account ID and the merchant ID, identifying a subsequent value from the subsequent transaction;
amending the first field with the subsequent value and updating the total in the second field as a sum of the value of the transaction and the subsequent value; and
processing the electronic transaction request as the single request.

15. The non-transitory computer readable medium of claim 14, further comprising providing a graphical user interface (GUI) on the mobile device of the user for configuring preferences for the predetermined secondary value.

16. The non-transitory computer readable medium of claim 15, wherein the preferences comprise at least one or more of the following: a fixed value of the predetermined secondary value; a region where a merchant is located, a type of the merchant, and whether a review of the merchant has received.

17. The non-transitory computer readable medium of claim 14, wherein monitoring comprises monitoring transactions via the mobile device.

18. The non-transitory computer readable medium of claim 14, wherein the account ID of the user identifies a first payment account used in the electronic transaction request.

19. The non-transitory computer readable medium of claim 14 wherein the account ID of the user identifies a second payment account used in the subsequent transaction.

20. The non-transitory computer readable medium of claim 14, further comprising determining one of the following: a pre-tax amount before the predetermined secondary value is added to the total, a pre-tax amount before the subsequent value is added to the total; and a post-tax amount of the total.
